(19) United States
(12) Patent Application Publication
(10) Pub. No.: US 2021/0246879 A1
(43) Pub. Date: Aug. 12, 2021

(54) TOWER DAMPER

(71) Applicant: MHI Vestas Offshore Wind A/S, Aarhus N (DK)

(72) Inventor: Peter Sigfred Mortensen, Risskov (DK)

(21) Appl. No.: 16/973,859

(22) PCT Filed: Jun. 26, 2019
(86) PCT No.: PCT/EP2019/066937

§ 371 Date: Dec. 10, 2020

(30) Foreign Application Priority Data
Jun. 29, 2018 (EP) 18180750.4

(51) Int. Cl. F03D 13/20; F03D 80/00

(52) U.S. Cl. CPC F03D 13/20; F16F 15/04; F03D 80/00

(57) ABSTRACT

The present invention relates to an impact damper assembly for damping oscillations of an associated tower structure, the impact damper assembly comprising one or more impact dampers each comprising a suspension arrangement adapted to be suspended between at least two vertically distanced suspension positions of the tower structure, an impact mass secured to the suspension arrangement, the impact mass being adapted to collide with the tower structure in response to movements thereof, and a tensioner adapted to apply a defined tension to the suspension arrangement in order to adjust the damping characteristics of the impact damper. The present invention further relates to a wind turbine tower having an impact damper assembly attached thereto and a method for damping tower structure oscillations using an impact damper assembly.

### FIELD OF THE INVENTION

The present invention relates to an impact damper assembly comprising one or more impact dampers each having adjustable damping characteristics.

### BACKGROUND OF THE INVENTION

Vortex shedding is a phenomenon that occurs due to instability of the flow around an object, such as a wind turbine tower. Low-pressure vortices are created on the downstream side of the tower and intermittently detach from either side of the tower. The tower will tend to move towards the low pressure, i.e. an alternating force is applied to the tower. The frequency by which the force alternates from side to side depends on the diameter of the tower and the wind speed. At a certain wind speed, the frequency of the alternating forces coincides with the natural frequency of the wind turbine tower. This wind speed is known as the critical wind speed. At this wind speed the tower will start to oscillate.

The amplitudes of the oscillations at the critical wind speeds depend on the structural damping of the wind turbine tower. If no additional damping is added to the wind turbine tower the oscillations can result in severe deflections of the wind turbine tower. This may lead to structural damage and/or damage to equipment or personnel in the wind turbine tower.

It may be seen as an object of embodiments of the present invention to provide a tower damper for damping oscillations a wind turbine tower or wind turbine tower section.

It may be seen as a further object of embodiments of the present invention to provide a simple and robust impact damper assembly for damping in particular oscillations originating from the second natural frequency of a wind turbine tower or wind turbine tower section.

### BRIEF DESCRIPTION OF THE INVENTION

The above-mentioned objects are complied with by providing, in a first aspect, an impact damper assembly for damping oscillations of an associated tower structure, the impact damper assembly comprising one or more impact dampers each comprising
a) a suspension arrangement adapted to be suspended between at least two vertically distanced suspension positions of the tower structure,
b) an impact mass secured to the suspension arrangement, the impact mass being adapted to collide with the tower structure in response to oscillations thereof, and
c) a tensioner adapted to apply a defined tension to the suspension arrangement in order to adjust the damping characteristics of the impact damper.

Thus, according to the first aspect of the present invention an impact damper assembly comprising one or more impact dampers having adjustable damping characteristics is provided. The adjustable damping characteristics of the one or more impact dampers may be provided by adjusting the tension applied to the suspension arrangement. By adjusting the tension applied to the suspension arrangement the damping characteristics of the one or more impact dampers may be adjusted to dampen a selected natural frequency of the tower structure, such as the second natural frequency of the tower structure. This is a major advantage as the natural frequency of the tower structure may change dependent on the stage of completion of the wind turbine tower as weight and height changes.

The tensioner may be implemented in various ways, such as an in-line tensioner forming part of the suspension arrangement. The tensioner may be controlled manually, i.e. the tension applied to the suspension arrangement may be set manually. Alternatively, the tensioner may be controlled in real time, i.e. automatically, in response to measured Vortex-induced oscillations of the tower structure. Automatic and real time control of the tensioner may be performed via an electric motor or a linear actuator in combination with a suitable control loop involving a control unit.

The impact damper assembly may be attached to the tower structure which may involve a completely assembled wind turbine tower or a wind turbine tower section. The impact damper assembly may be attached to either the inside or outside of the wind turbine tower or wind turbine tower section.

The impact damper assembly may further comprise a sensor adapted to measure movements of the tower structure, and a control unit for adjusting the defined tension to the suspension arrangement in response to measured movements of the tower structure. The adjustment of the defined tension to the suspension arrangement in response to measured movements of the tower structure may be performed in real time in order to facilitate that for example the second natural frequency of the tower structure, at any time, may be properly damped.

In terms of attaching the impact damper assembly to the tower structure each impact damper may further comprise fastening elements, such as brackets, wherein a fastening element may be located at each suspension position for suspending the suspension arrangement of each impact damper. The fastening elements of each impact damper may be adapted to be attached to two vertically distanced tower flanges of the tower structure. In this way the tower flanges may become the vertically distanced suspension positions. One or both of the fastening elements may be adapted to be attached to brackets connected to the tower wall and/or a platform arranged in the tower.

The suspension arrangement may comprise a wire. This wire may be adapted to be suspended between the vertically distanced suspension positions of the tower structure. By adjusting the tension applied to the wire (optionally in real time) the damping characteristics of a given impact damper may be constantly adjusted to dampen a selected natural frequency of the tower structure in a desired and/or an optimal manner.

The impact damper assembly may comprise at least three impact dampers, i.e. 3, 4, 5, 6 etc. impact dampers. To ensure proper damping of the tower structure the impact dampers may be evenly distributed along a periphery of the tower structure. Thus, if for example the impact damper assembly comprises three impact dampers an angular separation of approximately 120 degrees is preferably provided between the impact dampers. In case of 6 impact dampers an angular separation of approximately 60 degrees is preferably provided.

The impact damper assembly may be adapted to dampen tower structure oscillations having a natural frequency below 11 Hz, such as below 5 Hz, such as below 2 Hz, such as below 1.5 Hz, such as below 1 Hz. The natural frequency of the tower structure may be higher than 0.2 Hz, such as higher than 0.5 Hz, preferably within the range of 0.8 to 1.0 Hz. As mentioned above the impact damper assembly of the present invention may in particular be intended to dampen tower oscillations at or near the second natural frequency of the tower structure, which was estimated to be the range below 2 Hz and higher than 0.5 Hz. In a further embodiment, the impact damper assembly is particularly intended to dampen tower oscillations at or near the third natural frequency of the tower structure, which was estimated to be the range below 11 Hz and higher than 0.8 Hz.

The impact mass of the one or more impact dampers may be at least partly encapsulated in a resilient or elastic material, such as rubber, in order to reduce load on the tower structure during collision. The mass of the impact mass of the one or more impact dampers may be around 2-3% of the tower turbine generalized mass even thou the mass may be lower such as for example 1-3% or 0.5-3% of the tower turbine generalized mass.

The impact mass of the one or more impact dampers may be positioned at or near a centre point of the suspension arrangement.

The impact damper assembly according to the present invention is also effective against oscillations originating from third or higher natural frequency of a wind turbine tower when tuned to such frequencies. By use of an automatic and real time control of the tensioner, the impact damper assembly may hence be effective against oscillations of several (natural) frequencies of a wind turbine tower. It should be noted that oscillations of higher than second mode is not typically observed in the presently used wind turbine designs, but the impact damper assembly according to the invention will be effective to these higher modes should future designs of wind turbine towers lead to higher modes of oscillation.

In a second aspect the present invention relates to a wind turbine tower having an impact damper assembly according to the first aspect secured thereto. The impact damper assembly may be intended to dampen Vortex induced oscillations of the wind turbine tower, such as Vortex induced oscillations of the wind turbine tower at or near the second natural frequency of the wind turbine tower.

The term wind turbine tower is here to be understood as a partly or completely assembled wind turbine tower with or without the nacelle and optionally the rotor. In other words, the invention concerns both a completed wind turbine generator as well as a partly assembled wind turbine generator or wind turbine tower during assembly, transportation and at energy production position.

The impact damper assembly may be attached to the wind turbine tower in a manner so that the vertical position of the impact mass of an impact damper is between 40% to 80%, preferably between 45% to 70%, more preferably between 50% to 66%, such as about 66% of the height of the wind turbine tower. Here, the height of the wind turbine tower is defined as the distance from the attachment of the tower to the foundation and to the attachment to the nacelle, i.e. from the bottom flange of the lowermost tower section to the top flange of the uppermost tower section.

For conical towers and towers with conical sections is it preferred to place the impact mass above or above the middle of the tower, such as 50% to 66% or about 66% of the height of the wind turbine tower.

For the second mode tower oscillations the tower deflection will reach its extremum at approximately this location. Therefore, the effect of the damper will be highest towards reducing second mode tower oscillations when located at this position in relation to the tower as opposed to first mode tower oscillations, where the deflections are most pronounced at the top to the tower. Dampers for reducing first mode tower oscillations using an impact mass are therefore placed as high as possible in the tower, such as at 90% to 100% or 95% to 100% of the height of the wind turbine tower. The damper of the present invention is especially suitable for locations lower than the high positions of dampers for first mode tower oscillations as the damper of the present invention requires space above and below the impact mass (see above for paragraphs for identified advantageous positioning of the impact mass of the damper of the present invention).

Moreover, the suspension arrangement of an impact damper may be configured with a distance between the suspension positions between 5 to 20% of the height of the wind turbine tower. In meters, the distance between the suspension positions may be between 5 to 25 m. The larger distances are typically realized when the suspension positions are flanges of tower sections, whereas the shorter distances typically are realized when the suspension positions are a combination of one or more flanges, brackets on the tower wall and platforms in the tower.

The wind turbine tower may further comprise load spreading devices attached to the wind turbine tower in order to reduce loads on the wind turbine tower during the repeated collision with the impact mass. The load spreading device may include a resilient material attached to the wind turbine tower at the point of collision.

The impact damper assembly attached to the wind turbine tower may comprise three impact dampers being angularly spaces preferably by approximately 120 degrees around the periphery of the wind turbine tower. It should be noted that the impact damper assembly may comprise a different number of impact dampers, such as 6, 9, 12 etc. impact dampers preferably being evenly distributed around the periphery of the wind turbine tower. Each of the three impact dampers are secured to vertically neighbouring tower flanges via brackets or otherwise vertically distanced suspension positions like brackets on the tower wall or platforms in the tower.

As addressed above the impact damper assembly may be adjusted to dampen the second natural frequency of the wind turbine tower.

In a third aspect the present invention relates to a method for damping preselected oscillations of a tower structure using an impact damper, the method comprising the steps of
a) suspending a suspension arrangement having an impact mass secured thereto between at least two vertically distanced suspension positions of the tower structure, the impact mass being adapted to collide with the tower structure in response to oscillations thereof, and
b) applying a defined tension to the suspension arrangement in order to adjust the damping characteristics of the impact damper.

The implementation of the impact damper may be as discussed in relation to the first aspect of the present invention. Thus, the impact damper may form part of an impact damper assembly comprising one or more impact dampers. Thus, the impact damper assembly may comprise three impact dampers which are suspended between vertically shifted tower flanges. Moreover, the three impact dampers may be angularly spaces by approximately 120 degrees around the periphery of the tower structure.

As addressed above, the impact damper assembly may comprise a sensor adapted to measure movements of the tower structure, and a control unit for adjusting the defined tension to the suspension arrangement in response to measured movements of the tower structure. The method according to the third aspect of the present invention may thus comprise the step of adjusting the defined tension to the suspension arrangement in response to measured movements of the tower structure in real time. This step facilitates that for example the second natural frequency of the tower structure, at any time, may be properly damped.

### BRIEF DESCRIPTION OF THE DRAWINGS

The present invention will now be explained in further details with reference to the accompanying figures, wherein

FIG. 1 shows a wind turbine generator and an assembled wind turbine tower,

FIG. 2 shows an impact damper according to the present invention on a vertical section of the tower wall,

FIG. 3 shows an impact damper assembly comprising three impact dampers being evenly distributed along the periphery of a horizontal section of a wind turbine tower, and

FIG. 4 shows a very simple flow-chart of the method according to the present invention.

While the invention is susceptible to various modifications and alternative forms specific embodiments have been shown by way of examples in the drawings and will be described in details herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE INVENTION

In a general aspect the present invention relates to an impact damper assembly for damping oscillations of an associated tower structure, such as a wind turbine tower, to which the impact damper assembly is attached. The impact damper assembly comprises one or more impact dampers. Each impact damper comprises a tensioner adapted to apply a defined tension to a suspension arrangement suspending an impact mass in order to adjust the damping characteristics of the impact damper. The damping characteristics of each impact damper may thus be adjusted (preferably in real time) in response to measured movements of the tower structure to which tower structure the impact damper assembly is attached.

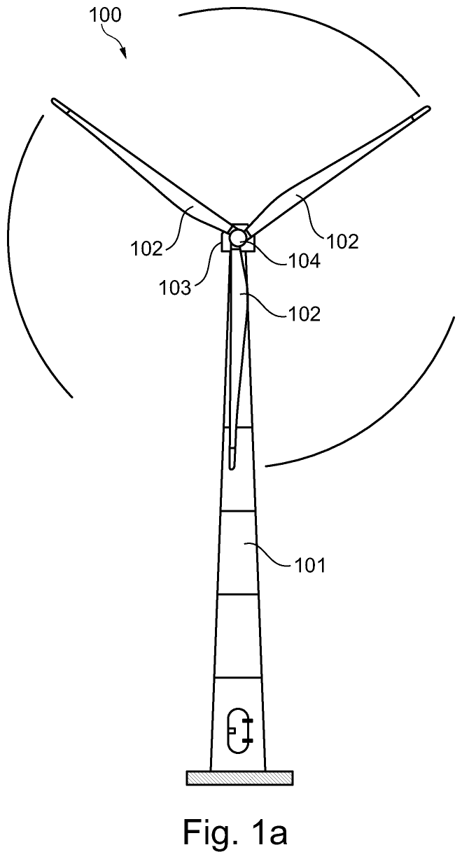

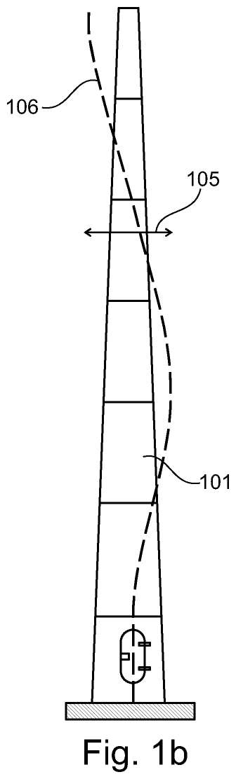

Referring now to FIG. 1 a wind turbine generator and a wind turbine tower are depicted in FIGS. 1a and 1b, respectfully. In FIG. 1a the wind turbine generator 100 comprises a wind turbine tower 101, a nacelle 103 as well as three rotor blades 102 secured to a rotor hub 104. The wind turbine generator converts wind energy into electrical energy via at least a power generator and a power converter system.

When assembling wind turbine generators of the type depicted in FIG. 1a the wind turbine tower 101 is assembled first, cf. FIG. 1b. Prior to mounting the nacelle 103, the hub 104 and the rotor blades 102 on the wind turbine tower 101, the free-standing tower may be exposed to Vortex-induced oscillations which will cause the free standing wind turbine tower 101 to sway or deflect from side to side as indicated by the arrow 105 in FIG. 1b. As seen in FIG. 1b the wind turbine tower comprises a plurality of tower sections arranged on top of each other in order to form the complete wind turbine tower. Tower deflections in accordance with the second natural frequency of a tower structure are indicated by the dashed line 106 in FIG. 1b. It should be noted that also wind turbine towers that have still not reached their final height may also sway or deflect if exposed to Vortex-induced oscillations.

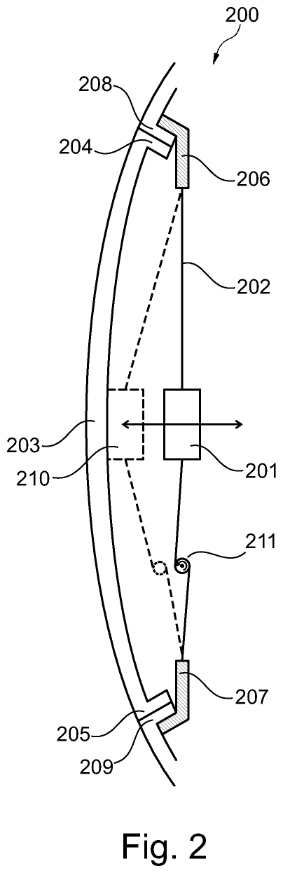

Uncontrolled swaying or deflections of wind turbine towers due to Vortex-induced oscillations can be effectively counteracted by the impact damper assembly 200 according to the present invention as depicted in FIG. 2. With reference to FIG. 2, a vertical section of deflected tower wall 203 of a wind turbine tower is depicted. FIG. 2 is a schematic representation and not to scale. Particularly, the deflections are exaggerated for illustrative purposes only as the tower wall usually is substantially straight and vertical. As seen in FIG. 2, the wind turbine tower comprises a plurality of tower sections arranged on top of each other, and bolted together at tower flanges 208, 204 and 205, 209. As depicted in FIG. 2 brackets 206, 207 are attached to the tower flanges separated by a vertical distance (here 208, 209, respectively, but this may also be for example 204, 205 respectively). Between the two brackets 206, 207 an impact mass 201 is suspended in a suspension arrangement comprising a wire 202 which may be a through-going wire connected to brackets 206, 207. The natural frequency of the impact damper depends on a plurality of parameters, including the tension applied to the wire 202, the mass of the impact mass 201, as well as the length of the wire 202. The natural frequency of the impact damper may be changed by adjusting one or more of these parameters.

As the wind turbine tower deflects due to Vortex-induced oscillations the impact mass 201 will move as illustrated by the horizontal arrow. At some stage the impact mass 201 will collide with the tower wall 203, cf. the dashed part in FIG. 2 with reference numeral 210 indicating the displaced impact mass. The collision between the tower wall and the impact mass significantly reduces the Vortex-induced oscillations and thereby the deflections of the wind turbine tower.

The natural frequency of the impact damper as well as the collision force between the tower wall and the impact mass may be adjusted by an in-line tensioner 211 adapted to apply a defined tension to the wire 202. Thus, by adjusting the tension applied to the wire 202 the damping characteristics of the impact damper may be adjusted.

The in-line tensioner 211 may be controlled manually, i.e. the tension applied to the wire 202 may for example be set manually. Alternatively, the in-line tensioner 211 may be controlled in real time, i.e. automatically, in response to measured Vortex-induced oscillations of the wind turbine tower. Automatic control of the in-line tensioner 211 may be performed via an electric motor or a linear actuator in combination with a suitable control loop involving a control unit. The impact damper assembly according to the present invention may thus comprise a sensor adapted to measure Vortex-induced oscillations of the wind turbine tower, and a control unit for adjusting, in real time, the tension applied to the wire 202 in response to measured movements of the wind turbine tower in order to reduce Vortex-induced oscillations of the wind turbine tower, in particular at or near the second natural frequency of the wind turbine tower. Even thou the natural frequency of the impact damper could be changed by adjusting any one of the parameters mentioned above (e.g. mass and length of wire), and despite change in mass is much more simple to carry out, it was found to be highly advantageous to adjust the natural frequency by changing the tension applied to the wire as this allows for fast adjustment, which may be carried out automated and from a distance. Particularly for offshore wind turbines being able to change the tension applied to the wire to adjust the natural frequency of the impact damper turned out to be highly advantageous. Also, the use of a change in tension applied to the wire to adjust the natural frequency of the impact damper was found to be advantageous and particularly for offshore wind turbines.

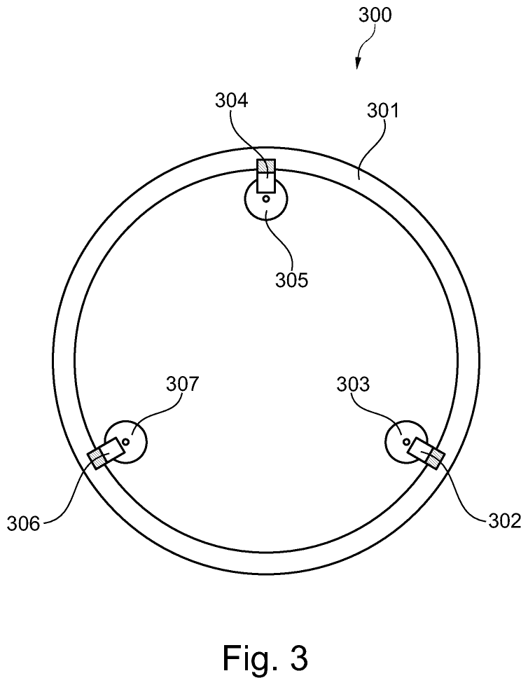

The impact damper according to the present invention comprises at least three impact dampers evenly distributed along a periphery of the wind turbine tower. In case the impact damper assembly comprises three impact dampers these impact dampers are preferably separated by approximately 120 degrees, cf. FIG. 3. The impact damper assembly is adapted to dampen tower oscillations having a frequency in the range 0.6 Hz to 1.5 Hz, which was found to be the typical frequencies for second mode tower oscillations and may be extended the range higher than 0.5 Hz and below 2 Hz.

In order to reduce load on the wind turbine tower structure during collision the impact mass 201 of the impact damper is preferably at least partly encapsulated in a resilient or elastic material, such as rubber. The shape of the impact mass may be various, including cylindrical and spherical shapes. The impact mass of the impact damper may be positioned at or near a centre point of the suspension arrangement, i.e. at or near the centre between the brackets 206, 207. The mass of the impact mass typically amounts 2-3% of the generalized mass of the tower turbine but may be lower such as for example 1-3% or (particularly in cases with fast and exact automatic changing of tension applied to the suspension arrangement) 0.5-3% of the generalized mass of the tower turbine.

FIG. 3 depicts a horizontal section of tower with an impact damper assembly 300 comprising three impact dampers with associated impact masses 303, 305, 307 being suspended from respective brackets 302, 304, 306 attached to tower flange 301. As depicted in FIG. 3 the impact dampers are evenly distributed along the tower flange 301, i.e. being separated by approximately 120 degrees.

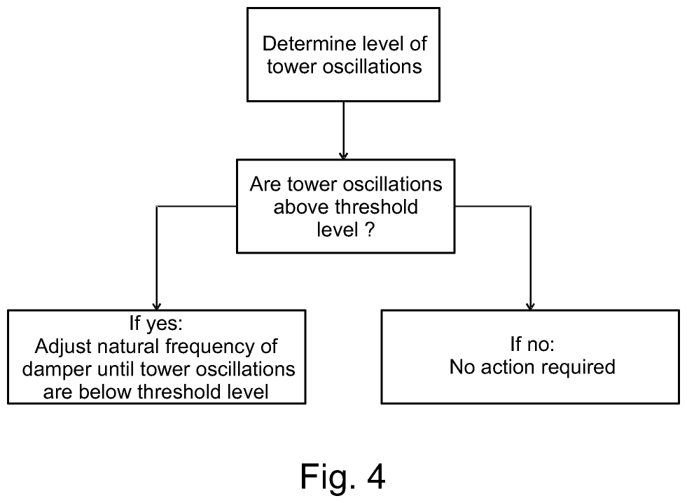

As addressed above the present invention also relates to a method for damping preselected oscillations of a tower structure using an impact damper assembly comprising one or more impact dampers as depicted in FIGS. 2 and 3. A preselected oscillation to be damped may be the second natural frequency of the tower structure. To ensure optimum effect of the damper, the impact damper assembly may comprise a sensor adapted to measure movements of the tower structure, and a control unit for adjusting the tension of a suspension arrangement in response to measured movements of the tower structure. The method according to the present invention is advantageous in that it thus comprises the step of adjusting the tension of the suspension arrangement in response to measured movements of the tower structure in real time. This step facilitates that for example the second natural frequency of the tower structure, at any time, may be properly dampened. Furthermore, since the frequency of the damper can be adjusted precisely to the actual occurring oscillation of the tower, a smaller impact mass can be used than in the case where no adjustment of damper characteristic was possible. Also, onsite installation and commissioning time of the damper is significantly reduced when the tension of the suspension arrangement can be done from a distance and preferably automated as fine tuning can be made after installation or completely avoided. FIG. 4 shows a very simple flow-chart of the method according to the present invention. Initially the tower oscillations of the wind turbine tower to which the impact damper assembly is attached are determined. If the determined tower oscillations are below an acceptable threshold level no action is required. If, on the other hand, the determined tower oscillations are above an acceptable threshold level the tension of a suspension arrangement is adjusted until for example the oscillations originating from the second natural frequency of the tower structure is below the acceptable threshold level.

1. An impact damper assembly for damping oscillations of an associated tower structure when secured thereto, the impact damper assembly comprising one or more impact dampers each comprising
a suspension arrangement adapted to be suspended between at least two vertically distanced suspension positions of the tower structure,
an impact mass secured to the suspension arrangement, the impact mass being adapted to collide with the tower structure in response to oscillations thereof, and
a tensioner adapted to apply a defined tension to the suspension arrangement in order to adjust the damping characteristics of the impact damper.

2. The impact damper assembly according to claim 1, further comprising a sensor adapted to measure movements of the tower structure, and a control unit for adjusting the defined tension to the suspension arrangement in response to measured movements of the tower structure.

3. The impact damper assembly according to claim 1, wherein each impact damper further comprises fastening elements, such as brackets, wherein a fastening element is located at each suspension position for suspending the suspension arrangement of each impact damper.

4. The impact damper assembly according to claim 1, wherein the impact damper assembly comprises at least three impact dampers.

5. The impact damper assembly according to claim 1, wherein the impact damper assembly is adapted to dampen tower structure oscillations having a natural frequency below 2 Hz, such as below 1.5 Hz, such as below 1 Hz.

6. The impact damper assembly according to claim 1, wherein the impact mass of the one or more impact dampers is at least partly encapsulated in a resilient or elastic material, such as rubber, in order to reduce load on the tower structure during collision.

7. The impact damper assembly according to claim 1, wherein the impact mass of the one or more impact dampers is positioned at or near a centre point of the suspension arrangement.

8. A wind turbine tower having an impact damper assembly according to claim 1 secured thereto.

9. The wind turbine tower according to claim 8, wherein the impact damper assemblies is attached to the wind turbine tower in a manner so that the vertical position of the impact mass of an impact damper is between 40% to 80%, preferably 45% to 70%, more preferably between 50% to 66%, such as at about 66% of the height of the wind turbine tower.

10. The wind turbine tower according to claim 8, wherein the suspension arrangement of an impact damper is configured with a distance between the suspension positions between 5 to 20% of the height of the wind turbine tower or 5 to 25 m.

11. The wind turbine tower according to claim 8, further comprising load spreading devices attached to the wind turbine tower in order to reduce load on the wind turbine tower at collision with the impact mass.

12. The wind turbine tower according to claim 8, wherein the impact damper assembly comprises three impact dampers being angularly spaces by approximately 120 degrees around the periphery of the wind turbine tower.

13. A method for damping preselected oscillations of a tower structure using an impact damper, the method comprising the steps of
suspending a suspension arrangement having an impact mass secured thereto between at least two vertically distanced suspension positions of the tower structure, the impact mass being adapted to collide with the tower structure in response to oscillations thereof, and
applying a defined tension to the suspension arrangement in order to adjust the damping characteristics of the impact damper.

14. The method according to claim 13, wherein the step of applying a defined tension to the suspension arrangement comprises the steps of measuring movements of the tower structure, and adjusting the defined tension to the suspension arrangement in response to measured movements of the tower structure.

15. The method according to claim 14, wherein the preselected oscillations of the tower structure correspond to the second natural frequency of the tower structure.
